(19) United States
(12) Patent Application Publication
(10) Pub. No.: US 2011/0076353 A1
(43) Pub. Date: Mar. 31, 2011

(54) PHOTO- IMPRINTING PROCESS, MOLD-DUPLICATING PROCESS, AND MOLD REPLICA

(76) Inventors: Masamitsu Shirai, Osaka (JP); Yoshihiko Hirai, Sakai-shi (JP)

(21) Appl. No.: 12/920,519

(22) PCT Filed: Feb. 13, 2009
(86) PCT No.: PCT/JP2009/052402

§ 371 Date: Nov. 24, 2010

(30) Foreign Application Priority Data
Mar. 14, 2008 (JP) 2008-065777

(51) Int. Cl. B29C 59/02; B29C 59/16

(52) U.S. Cl. 425/385; 264/447

(57) ABSTRACT

Provided are processes such as a photo-imprinting process having high productivity without causing defacement of an expensive mold. In the photo-imprinting process of the invention, a pattern is transferred to a resin layer 2 by forming the resin layer 2 by applying a rework type photocrosslinking/curing resin to a substrate 1, pressing a mold 3 to the resin layer 2, irradiating the resin layer 2 with light having a first wavelength, and detaching the mold 3 from the resin layer 2. The rework type photocrosslinking/curing resin crosslinks/cures by irradiation with light having the first wavelength and is solubilized in a solvent by irradiation with light having a second wavelength shorter than the first wavelength or by heating. Therefore, even if grooves of the mold 3 are obstructed with the crosslinked/cured resin, the crosslinked/cured resin can be easily removed by resolubilizing it by, for example, irradiating the mold 3 with light having the second wavelength.

### TECHNICAL FIELD

The present invention relates to a novel photo-imprinting process, a mold-duplicating process for duplicating a mold by using the photo-imprinting process, and a duplicated mold replica.

### BACKGROUND ART

Imprinting processes have gained attention as micromachining methods for efficiently and inexpensively producing electronic devices such as large-scale integrated circuits and liquid crystal displays, optical devices such as optical integrated circuits and optical disks, and chemical and bio-relating devices such as immunoanalytical chips and DNA chips.

The imprinting processes can be roughly classified into two types: thermal imprinting and photo imprinting. The thermal imprinting process is a method for transferring a concave and convex pattern (hereinafter abbreviated as pattern) formed on a mold to a resin by pressing the mold to the resin softened by heat, curing the resin by cooling it, and then detaching the mold from the resin.

Thus, in the thermal imprinting process, the resin has to be pressed in a softened state, which has a problem in that a large-scale manufacturing apparatus having a heating mechanism and a pressing mechanism that can supply a high pressing pressure is necessary.

In addition, the process needs time for heating and cooling a resin, which has a problem of a reduction in productivity. Furthermore, a resin expands or contracts when it is heated or cooled, which causes a problem of a difficulty in production of a precise product.

On the other hand, the photo-imprinting process is a method for transferring a pattern formed on a mold to a resin by curing a photo-curing resin by irradiation with electromagnetic radiation, such as ultraviolet light, while pressing a transparent mold to the photo-curing resin, and then detaching the mold from the photo-cured resin (see Patent Literature 1).

In the photo-imprinting process, the pressing pressure may not be high and, in some cases, may not be applied, as long as electromagnetic radiation can be irradiated in a state in that the mold is filled with the photo-curing resin. Therefore, the photo-imprinting process does not need a large-scale manufacturing apparatus, unlike the thermal imprinting process.

In addition, since the photo-curing resin can be cured without being heated and does not need to be cooled before demolding, the productivity thereof is higher than that of the thermal imprinting process. Furthermore, since expansion and contraction due to heat are not caused in the resin and the mold, products with high precision can be produced. Thus, the photo-imprinting process has advantages compared to the thermal imprinting process.

However, even in the photo-imprinting process, as in the thermal imprinting process, an expensive mold (from several million yen to several tens of million yen) fabricated by, for example, photolithography of a transparent material, such as nickel, monocrystal silicon, quartz, or sapphire, is necessary. In addition, even in the photo-imprinting process, as in the thermal imprinting process, when the cured resin is detached from the mold, part of the resin exfoliated together with the mold due to pressure bonding or friction between the mold and the cured resin may obstruct the grooves of the mold.

Therefore, the photo-imprinting process also has a problem in that the grooves of a mold are obstructed by repetition of transference of the pattern, which defaces the expensive mold and causes a defect in part of the transferred pattern.

In order to solve this problem, it has been tried to reduce the adhesive force between a mold and a resin by treating the surface of the mold in advance with a mold release agent composed of, for example, a silane coupling agent or tried to produce a mold by a material that hardly adheres to a resin. However, the defacement of the mold cannot be completely prevented even if the treatment with a mold release agent is conducted or a non-adhesive material is used. In addition, the treatment with a mold release agent for each transfer has a problem of a reduction in productivity (see Patent Literature 2 and Non Patent Literature 1).

Furthermore, it has been tried to conduct photo imprinting using a replica of an expensive mold without directly using the mold (see Patent Literature 3). However, it is difficult to produce a precise replica from a mold, and there is a possibility of defacing the mold by that the grooves of the mold are obstructed when the replica is produced.

In addition, in the above-mentioned photo-imprinting process, a resin layer also remains in an area that has been pressed with the convex portion of the mold (hereinafter abbreviated as residual film), and in order to remove this residual film, dry etching with, for example, an oxygen gas is necessary. Thus, the treatment of the residual film has been a cause of a reduction in productivity of the photo-imprinting process (see Non Patent Literatures 1 and 2).

At the same time, many researchers, including the present inventors, have studied on rework type photocrosslinking/curing resins, which crosslink/cure by irradiation with light having a specific wavelength and are resolubilized in a solvent by irradiation with light having a wavelength different from the above-mentioned wavelength or by heating (see Non Patent Literature 3).

### CITATION LIST

### Patent Literature

PTL 1: Japanese Unexamined Patent Application Publication No. 2007-329276

PTL 2: Japanese Unexamined Patent Application Publication (Translation of PCT Application) No. 2005-515617

PTL 3: Japanese Unexamined Patent Application Publication No. 2007-245684

### Non Patent Literature

NPL 1: written and edited by Ryutaro Maeda, “Nano-imprint no Hanashi (Topics on nano-imprint)”, The Nikkan Kogyo Shimbun, Ltd., 2005

NPL 2: by Jun Taniguchi, “Hajimete no nano-imprint gijutsu (Introduction to nano-imprint technology)”, Kogyo Chosakai Publishing, Inc., 2005

NPL 3: Masamitsu Shirai, “Rework-noh wo yuhsuru hikari kakyo kouka jushi (Photocrosslinkable Polymers with Reworkable Properties)” Kobunshi Ronbunshu (Japanese Journal of Polymer Science and Technology), vol. 65, No. 2, pp. 113-123 (February 2008)

### SUMMARY OF INVENTION

Accordingly, it is an object of the invention to provide a photo-imprinting process with high productivity without defacing an expensive mold, a mold-duplicating process capable of inexpensively and precisely duplicating an expensive mold without defacing it, and a mold replica duplicated by the mold-duplicating process.

The present inventors have found the fact that the above-mentioned problems can be solved by using a rework type photocrosslinking/curing resin and have accomplished the invention.

That is, the photo-imprinting process according to a first aspect of the invention is a process including, in the following order, an application step (1) of forming a resin layer by applying, to a substrate, a rework type photocrosslinking/curing resin that crosslinks/cures by irradiation with light having a first wavelength and is resolubilized in a solvent at least either by irradiation with light having a second wavelength shorter than the first wavelength or by heating; a pressing step (2) of pressing a mold to the resin layer; a first exposure step (3) of irradiating the resin layer with light having the first wavelength; and a pattern forming step (4) of forming a pattern by detaching the mold from the resin layer.

The photo-imprinting process according to a second aspect of the invention is the photo-imprinting process according to the first aspect, wherein the rework type photocrosslinking/curing resin includes a monomer (a) having photoradical polymerizable crosslinkable groups on both ends and an acid-decomposable group between the crosslinkable groups; a photoradical polymerization initiator (b) that generates a radical by irradiation with light having the first wavelength; and at least one of a photoacid generator (c) generating an acid by irradiation with light having the second wavelength and a thermoacid generator (c) generating an acid by heating.

The photo-imprinting process according to a third aspect of the invention is the photo-imprinting process according to the second aspect, wherein the photoradical polymerizable crosslinkable groups of the rework type photocrosslinking/curing resin are each a functional group selected from the group consisting of acrylate ester groups, methacrylate ester groups, vinylphenyl groups, and vinyl ester groups; and the acid-decomposable group of the rework type photocrosslinking/curing resin is a functional group selected from the group consisting of acetal groups, ketal groups, hemiacetal ester groups, tertiary carboxylate ester groups, carbonate ester groups, and sulfonate ester groups.

The photo-imprinting process according to a fourth aspect of the invention is the photo-imprinting process according to any one of the first to third aspects and further includes a second exposure step of irradiating the resin layer with light having the second wavelength.

The photo-imprinting process according to a fifth aspect of the invention is the photo-imprinting process according to any one of the first to fourth aspects and further includes a second exposure step of irradiating the mold detached from the resin layer with light having the second wavelength.

The photo-imprinting process according to a sixth aspect of the invention is the photo-imprinting process according to the first aspect, wherein the rework type photocrosslinking/curing resin includes a monomer (d) having photocationic polymerizable crosslinkable groups on both ends and a thermally decomposable group between the crosslinkable groups; and a photoacid generator (e) generating an acid by irradiation with light having the first wavelength.

The photo-imprinting process according to a seventh aspect of the invention is the photo-imprinting process according to the sixth aspect, wherein the photocationic polymerizable crosslinkable groups of the rework type photocrosslinking/curing resin are each a functional group selected from the group consisting of epoxy groups, vinyl ether groups, and oxetane groups; and the thermally decomposable group of the rework type photocrosslinking/curing resin is a functional group selected from the group consisting of acetal groups, ketal groups, tertiary carboxylate ester groups, carbonate ester groups, and sulfonate ester groups.

The photo-imprinting process according to an eighth aspect of the invention is the photo-imprinting process according to the first, sixth, or seventh aspect and further includes a heating step of heating the mold detached from the resin layer.

The mold-duplicating process according to a ninth aspect of the invention is a process including, in the following order, a first application step (1) of forming a first resin layer by applying, to a first substrate, a rework type photocrosslinking/curing resin that crosslinks/cures by irradiation with light having a first wavelength and is resolubilized in a solvent at least either by irradiation with light having a second wavelength shorter than the first wavelength or by heating; a pressing step (2) of pressing a mold to the first resin layer; an exposure step (3) of irradiating the first resin layer with light having the first wavelength; a pattern forming step (4) of forming a pattern by detaching the mold from the first resin layer; a second application step (5) of forming a second resin layer by applying, onto the pattern, a crosslinking/curing resin that crosslinks/cures at least either by irradiation with light having a wavelength longer than the second wavelength or by heating and is not resolubilized in a solvent by irradiation with light and heating; a second substrate disposing step (6) of disposing a second substrate on the second resin layer; a second resin layer crosslinking/curing step (7) of crosslinking/curing the second resin layer at least either by irradiation with light having a wavelength capable of crosslinking/curing the second resin layer or by heating; a solubilization step (8) of solubilizing the pattern at least either by irradiation with light having the second wavelength or by heating; and a removal step (9) of removing the solubilized pattern and the first substrate.

The mold-duplicating process according to a tenth aspect of the invention is the mold-duplicating process according to the ninth aspect, wherein the rework type photocrosslinking/curing resin includes a monomer (a) having photoradical polymerizable crosslinkable groups on both ends and an acid-decomposable group between the crosslinkable groups; a photoradical polymerization initiator (b) that generates a radical by irradiation with light having the first wavelength; and at least one of a photoacid generator (c) generating an acid by irradiation with light having the second wavelength and a thermoacid generator (c) generating an acid by heating.

The mold-duplicating process according to an eleventh aspect of the invention is the mold-duplicating process according to the tenth aspect, wherein the photoradical polymerizable crosslinkable groups of the rework type photocrosslinking/curing resin are each a functional group selected from the group consisting of acrylate ester groups, methacrylate ester groups, vinylphenyl groups, and vinyl ester groups; and the acid-decomposable group of the rework type photocrosslinking/curing resin is a functional group selected from the group consisting of acetal groups, ketal groups, hemiacetal ester groups, tertiary carboxylate ester groups, carbonate ester groups, and sulfonate ester groups.

The mold-duplicating process according to a twelfth aspect of the invention is the mold-duplicating process according to any one of the ninth to eleventh aspects and further includes a second exposure step of irradiating the mold detached from the first resin layer with light having the second wavelength.

The mold-duplicating process according to a thirteenth aspect of the invention is the mold-duplicating process according to the ninth aspect, wherein the rework type photocrosslinking/curing resin includes a monomer (d) having photocationic polymerizable crosslinkable groups on both ends and a thermally decomposable group between the crosslinkable groups; and a photoacid generator (e) generating an acid by irradiation with light having the first wavelength.

The mold-duplicating process according to a fourteenth aspect of the invention is the mold-duplicating process according to the thirteenth aspect, wherein the photocationic polymerizable crosslinkable groups of the rework type photocrosslinking/curing resin are each a functional group selected from the group consisting of epoxy groups, vinyl ether groups, and oxetane groups; and the thermally decomposable group of the rework type photocrosslinking/curing resin is a functional group selected from the group consisting of acetal groups, ketal groups, tertiary carboxylate ester groups, carbonate ester groups, and sulfonate ester groups.

The mold-duplicating process according to a fifteenth aspect of the invention is the mold-duplicating process according to any one of the ninth, thirteenth, and fourteenth aspects and further includes a heating step of heating the mold detached from the first resin layer.

The mold-duplicating process according to a sixteenth aspect of the invention is the mold-duplicating process according to any one of the ninth to fifteenth aspects, wherein the second substrate is made of a material having flexibility.

The mold-duplicating process according to a seventeenth aspect of the invention is the mold-duplicating process according to any one of the ninth to sixteenth aspects, wherein the solvent used in the removal step contains at least one solvent selected from the group consisting of water, alkali aqueous solutions, hot water, ethanol, and methanol.

The mold replica according to an eighteenth aspect of the invention is one that can be obtained by the mold-duplicating process according to any one of the ninth to seventeenth aspects.

According to the photo-imprinting process of the first aspect, even if the resin obstructs the grooves of a mold when the mold is removed from the crosslinked/cured resin layer, the obstructing resin can be removed by resolubilizing it in a solvent by irradiating the mold with light having the second wavelength or heating the mold.

According to the photo-imprinting process of the second, third, sixth, or seventh aspect, a photo-imprinting process utilizing known photopolymerization can be carried out, without considering the defacement of the mold, by using a monomer having a specific structure.

According to the photo-imprinting process of the fourth aspect, the residual film (base layer) on the substrate can be removed, without conducting dry etching, by adjusting the time of irradiation with the light having the second wavelength.

According to the photo-imprinting process of the fifth or eighth aspect, since the resin can be immediately removed even if it obstructs the grooves of the mold, it is unnecessary to confirm whether or not the grooves of the mold are obstructed by the resin at each imprinting. Therefore, the productivity of imprinting can be increased.

According to the mold-duplicating process of the ninth aspect, a mold replica can be easily duplicated by using a conventionally known crosslinking/curing resin. Furthermore, by performing the photo-imprinting process using this replica, it is possible to perform a photo-imprinting process that is faithful to the original mold, without defacing the original mold.

According to the mold-duplicating process of the tenth, eleventh, thirteenth, or fourteenth aspect, by using a monomer having a specific structure, a mold can be duplicated by known photopolymerization without considering the defacement of the original mold.

According to the mold-duplicating process of the twelfth or fifteenth aspect, since the resin can be immediately removed even if it obstructs the grooves of the mold, it is unnecessary to confirm whether or not the grooves of the mold are obstructed by the resin at each imprinting. Therefore, the duplication efficiency of a mold can be improved.

According to the mold-duplicating process of the sixteenth aspect, the mold replica can be attached to an outer surface of a roller, and an imprinting process can be sequentially performed at a high efficiency using this roller.

According to the duplicating process of the seventeenth aspect, the rework type photocrosslinking/curing resin after decomposition can be removed with less natural environmental pollution.

According to the mold replica of the eighteenth aspect, an imprinted product can be efficiently and inexpensively produced by using the inexpensive and precise replica instead of an expensive mold.

### BRIEF DESCRIPTION OF DRAWINGS

FIG. 1 is schematic diagrams illustrating a photo-imprinting process of the invention according to the order of the steps.

FIG. 2 is schematic diagrams illustrating a mold-duplicating process of the invention according to the order of the steps.

FIG. 3 is schematic diagrams illustrating types of rework type photocrosslinking/curing resins.

FIG. 4 is a diagram illustrating a synthesis path of DCA3, which is an example of the monomer contained in the rework type photocrosslinking/curing resin.

FIG. 5 is a schematic diagram illustrating a chemical reaction of the rework type photocrosslinking/curing resin by light irradiation.

FIG. 6 is optical micrographs of the primary patterns obtained by the photo-imprinting process of the invention.

FIG. 7 shows optical micrographs of the secondary patterns obtained by the mold-duplicating process of the invention.

FIG. 8 is a graph of the evaluation results of transferability of the photo-imprinting process and duplicatability of the mold-duplicating process of the invention when compared a mold, a primary pattern, and a secondary pattern using a profilometer.

FIG. 9 is a diagram illustrating a synthesis path of CHIS, which is an example of the thermoacid generator contained in another rework type photocrosslinking/curing resin.

FIG. 10 is a schematic diagram illustrating a chemical reaction of another rework type photocrosslinking/curing resin with light irradiation and heating.

FIG. 11 shows optical micrographs of the mold, primary pattern, and secondary pattern when another rework type photocrosslinking/curing resin is used.

### DESCRIPTION OF EMBODIMENTS

### 1. Photo-Imprinting Process

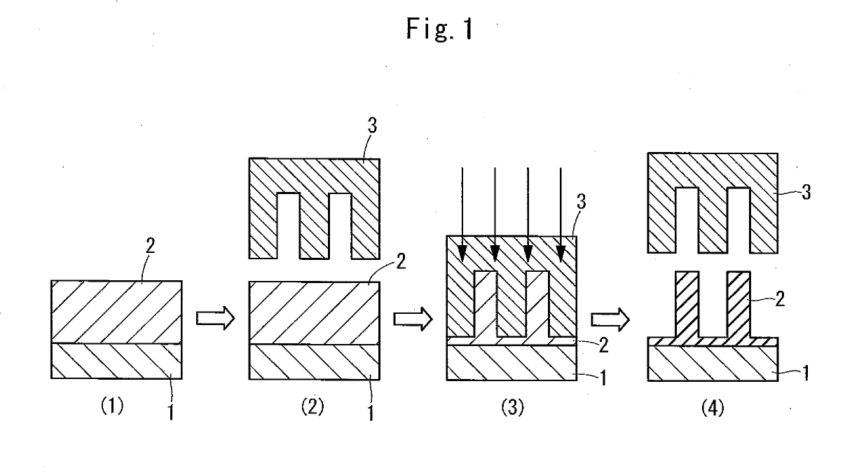

The photo-imprinting process of the invention includes an application step (1), a pressing step (2), a first exposure step (3), and a pattern forming step (4), in this order. Accordingly, each step will be described in detail based on FIG. 1.

### (1) Application Step

As shown in (1) of FIG. 1, the application step is a step of forming a resin layer 2 by applying a rework type photocrosslinking/curing resin to a substrate 1. The 1) rework type photocrosslinking/curing resin, 2) substrate, and 3) application method will be described below.

1) Rework Type Photocrosslinking/Curing Resin

The rework type photocrosslinking/curing resin is a resin that crosslinks/cures by irradiation with light having a first wavelength and is resolubilized in a solvent at least either by irradiation with light having a second wavelength shorter than the first wavelength or by heating. As the solvent, various types of solvents, such as an aqueous or organic solvent, can be used.

Examples of the rework type photocrosslinking/curing resin include rework type photocrosslinking/curing resins of radical photocuring type (A), which generate radicals and crosslink/cure by irradiation with light having a first wavelength, and are decomposed by irradiation with light having a second wavelength or by heating; and rework type photocrosslinking/curing resins of cationic photocuring type (B), which generate acids and crosslink/cure by irradiation with light having a first wavelength, and are decomposed by heating.

The rework type photocrosslinking/curing resin of radical photocuring type (A) contains, for example, a monomer (a) having photoradical polymerizable crosslinkable groups on both ends and an acid-decomposable group between the crosslinkable groups; a photoradical polymerization initiator (b) that generates a radical by irradiation with light having the first wavelength; and at least one of a photoacid generator (c) generating an acid by irradiation with light having the second wavelength and a thermoacid generator (c) generating an acid by heating.

The monomer (a) has photoradical polymerizable crosslinkable groups on both ends and an acid-decomposable group between the crosslinkable groups. Examples of the photoradical polymerizable crosslinkable group include acrylate ester groups, methacrylate ester groups, vinylphenyl groups, and vinyl ester groups. The acid-decomposable group is a functional group that is decomposed by an acid, and examples thereof include acetal groups, ketal groups, hemiacetal ester groups, tertiary carboxylate ester groups, and carbonate ester groups, and sulfonate ester groups.

Examples of such a monomer (a) include DCA3, which is used in Examples described below, DA1 shown by the following formula (I) (in the formula, R represents H or CH₃), and DA2 shown by the following formula (II) (in the formula, R represents H or CH₃).

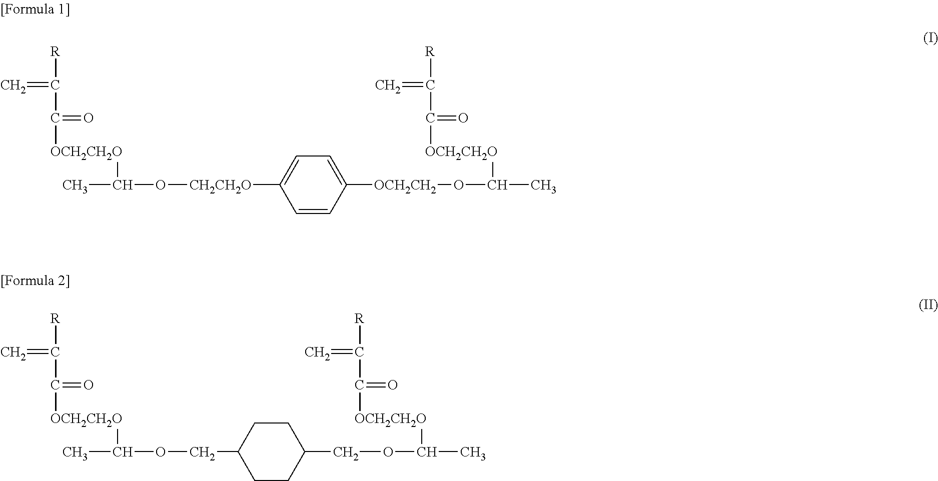

As the photoradical polymerization initiator (b), any known radical polymerization initiator that generates a radical by irradiation with light having the first wavelength can be used without particular limitation. However, since a high-pressure mercury lamp, which is inexpensive, can be used as the light source, compounds that generate radicals by irradiation with light having an i-line wavelength (365 nm) are preferred.

Examples of such a photoradical polymerization initiator (b) include 2,2-dimethoxy-2-phenyl-acetophenone (hereinafter abbreviated as DMPA), 2,4,6-trimethylbenzoyl diphenylphosphine oxide, and bisacylphosphine oxide.

Furthermore, as the photoacid generator (c), any known photoacid generator that generates an acid by irradiation with light having the second wavelength can be used without particular limitation. Since the second wavelength is shorter than the first wavelength, even if the rework type photocrosslinking/curing resin is irradiated with light having the first wavelength, an acid is not generated, though a radical is generated. Therefore, when the rework type photocrosslinking/curing resin is irradiated with light having the first wavelength, the molecules of the monomer are merely crosslinked/cured, and the monomer itself is not decomposed.

Examples of such a photoacid generator (c) include triphenylsulfonium trifluoromethanesulfonate (hereinafter abbreviated as TPST), 4,4′-bis(tert-butyl)phenyliodinium triflate (for example, trade name: BBI-105, a product of Midori Kagaku Co., Ltd.), triphenylsulfonium hexafluorophosphate, and triphenylsulfonium hexafluoroantimonate.

In addition, as the thermoacid generator (c), any known thermoacid generator that generates an acid by heating can be used without particular limitation. Since the thermoacid generator does not generate an acid by irradiation with light having the first wavelength, even if the rework type photocrosslinking/curing resin is irradiated with light having the first wavelength, an acid is not generated, though a radical is generated. Therefore, when the rework type photocrosslinking/curing resin is irradiated with light having the first wavelength, the molecules of the monomer are merely crosslinked/cured, and the monomer itself is not decomposed.

Examples of such a thermoacid generator (c) include p-toluenesulfonate (hereinafter abbreviated as CHTS), which is used in Examples described below, trifluoromethanesulfonate, and nonafluorobutanesulfonate.

On the other hand, the rework type photocrosslinking/curing resin of cationic photocuring type (B) contains, for example, a monomer (d) having photocationic polymerizable crosslinkable groups on both ends and a thermally decomposable group between the crosslinkable groups; and a photoacid generator (e) generating an acid by irradiation with light having the first wavelength.

The monomer (d) has photocationic polymerizable crosslinkable groups on both ends and a thermally decomposable group between the crosslinkable groups. Examples of the photocationic polymerizable crosslinkable group include epoxy groups, vinyl ether groups, and oxetane groups. The thermally decomposable group is a functional group that is decomposed by heat, and examples thereof include acetal groups, ketal groups, tertiary carboxylate ester groups, carbonate ester groups, and sulfonate ester groups.

Examples of such a monomer (d) include DCA1a shown by the following formula (III) (in the formula, R₁ represents CH₃, R₂ represents CH₃, and R₃ represents H), DCA1b shown by the formula (III) (in the formula, R₁ represents CH₃, R₂ represents CH₃, and R₃ represents CH₃), DCA1c shown by the following formula (IV), and DCA2 shown by the following formula (V).

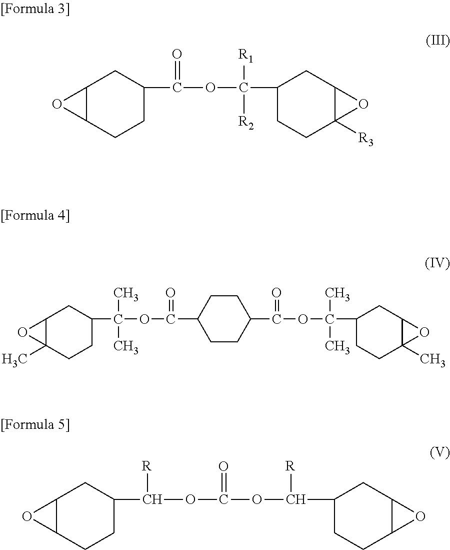

As the photoacid generator (e), any known photoacid generator that generates an acid by irradiation with light having the first wavelength can be used without particular limitation. Since the rework type photocrosslinking/curing resin of cationic photocuring type (B) is resolubilized in a solvent by heating, it is unnecessary to consider the irradiation with light having the second wavelength. Therefore, as the photoacid generator (e), a photoacid generator that generates an acid with light having a wavelength longer than that of light allowing the photoacid generator (c) to generate an acid can be used.

Examples of such a photoacid generator (e) include N-trifluoromethanesulfonyloxy-1,8-naphthylimide (hereinafter abbreviated as NITf) shown by the following Formula (VI) and p-toluenesulfonic acid 2-isopropylthioxanthone oxime (hereinafter abbreviated as ITXTS).

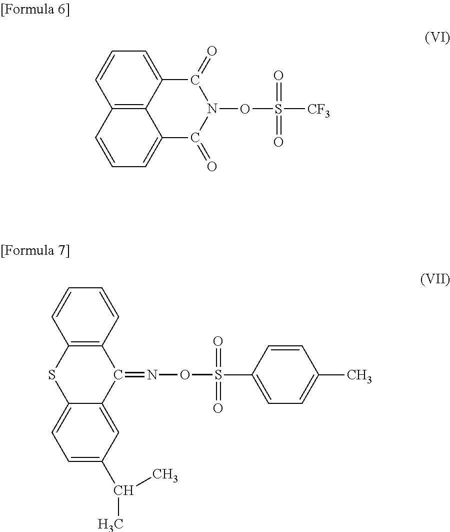

The amounts of these components can be appropriately changed depending on the purpose and the compound used. However, considering the application to a substrate, it is preferable to prepare a liquid having a relatively low viscosity of 1 to 300 mPa·s.

2) Substrate

As the substrate 1, any substrate that is usually used in photo-imprinting processes can be used without particular limitation. For example, a silicon monocrystal plate, a nickel plate, or a polyethylene terephthalate (hereinafter abbreviated as PET) film can be used.

3) Application Method

Application of the resin can be performed by any known method that is employed in photo-imprinting processes without particular limitation. For example, a method forming a film by spin coating or a method dropping a resin onto a substrate with a syringe, a dropper, or an ink jet can be used. Furthermore, it is suitable to form the resin layer on the substrate 1 so as to have about 1 μm or less, from the viewpoint of strength.

### (2) Pressing Step

As shown in (2) of FIG. 1, the pressing step is a step of pressing a mold 3 to the resin layer 2. As the mold 3, any mold produced by a known method, such as photolithography, using a material that is generally used for producing molds, such as monocrystal silicon, a nickel plate, quartz, or sapphire, can be used without particular limitation. Note that either the substrate 1 or the mold 3 must be able to transmit light having the first wavelength.

The pressure for pressing the mold 3 to the resin layer 2 is a level that is similar to that in usual photo-imprinting processes and is 10 atmospheres or less at the highest. In some cases, the mold 3 may be merely placed on the resin layer 2 without applying a pressure (which may be 1 atmosphere or less) depending on the viscosity of the rework type photocrosslinking/curing resin.

### (3) First Exposure Step

As shown in (3) of FIG. 1, the first exposure step is a step of crosslinking/curing the rework type photocrosslinking/curing resin constituting the resin layer 2 by irradiating the resin layer 2 with light having the first wavelength. Note that when the mold 3 transmits light having the first wavelength, the irradiation with light is performed from the mold 3 side as shown in (3) of FIG. 1 and that when the substrate 1 transmits light having the first wavelength, the irradiation with light is performed from the substrate 1 side.

The first wavelength is not limited as long as it is longer than the second wavelength described below, but is preferably 300 to 450 nm, considering the convenience. In particular, since a high-pressure mercury lamp, which is inexpensive, can be used, a light source generating i-line wavelength (365 nm) is preferred. The exposure time may be properly adjusted depending on the type of the rework type photocrosslinking/curing resin used, the thickness of the resin layer 2, and the wavelength and the intensity of the light source.

### (4) Pattern Forming Step

As shown in (4) of FIG. 1, the pattern forming step is a step of forming a pattern by detaching the mold 3 from the resin layer 2. The detachment of the mold 3 from the resin layer 2 can be performed by a known method that is employed in the photo-imprinting processes, for example, a method where the mold 3 is mechanically lifted upward in the state that the substrate 1 is fixed or, conversely, a method where the substrate 1 is mechanically lifted downward in the state that the mold 3 is fixed.

Thus, in the photo-imprinting process of the invention, a rework type photocrosslinking/curing resin is used as the resin layer 2. Therefore, even if the grooves of the mold 3 are obstructed, the defacement of the mold can be easily mended by resolubilizing the resin that has been crosslinked/cured in the grooves by performing at least either irradiating the mold 3 with light having the second wavelength or heating the mold 3.

Accordingly, by the photo-imprinting process of the invention, conventionally existing nano-imprint products, for example, semiconductors such as MOS, electronic devices such as functional films of liquid crystal displays, waveguides, optical devices such as light-emitting diodes and optical disks, bio-relating devices such as biosensors and cell culture sheets, and micro electro mechanical systems (MEMS) such as heads of ink-jet printers and pressure sensors, can be more efficiently and inexpensively produced.

### (5) Others

In the photo-imprinting process of the invention, when a rework type photocrosslinking/curing resin that is resolubilized in a solvent by irradiation with light having second wavelength and a mold that transmits light having the second wavelength are used, in addition to the steps (1) to (4), a second exposure step (5) of irradiating the resin layer 2 with light having the second wavelength may be performed after the first exposure step (3) or the pattern forming step (4). By performing the second exposure step, the residual film (base layer) on the substrate can be removed, without performing dry etching, by adjusting the time for irradiation with light having the second wavelength.

### 2. Mold-Duplicating Process

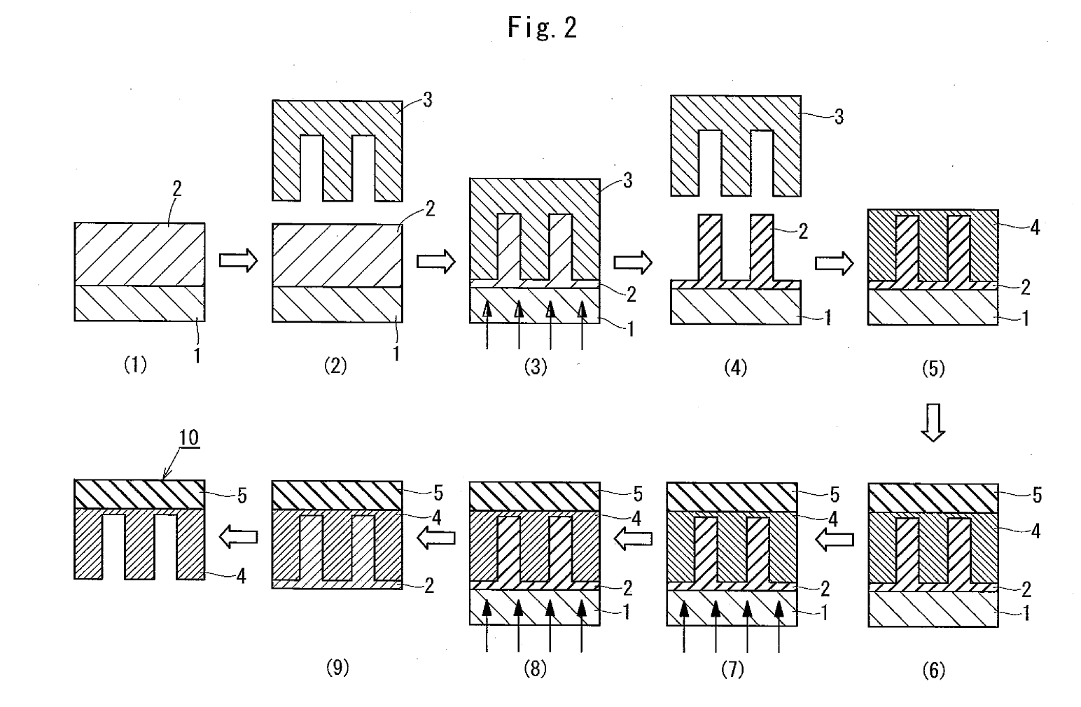

The mold-duplicating process of the invention is a process including a first application step (1), a pressing step (2), an exposure step (3), a pattern forming step (4), a second application step (5), a second substrate disposing step (6), a second resin layer crosslinking/curing step (7), a solubilization step (8), and a removal step (9), in this order. Accordingly, each step will be described in detail based on FIG. 2.

### (1) First Application Step

As shown in (1) of FIG. 2, the first application step is a step for forming a first resin layer 2 by applying a rework type photocrosslinking/curing resin onto a first substrate 1 transmitting light having the first wavelength. The application of the rework type photocrosslinking/curing resin is the same as the application step described in (1) of 1. Photo-imprinting process, and the first substrate 1 is the same as the substrate 1. Therefore, the description thereof is omitted.

### (2) Pressing Step

As shown in (2) of FIG. 2, the pressing step is a step of pressing a mold 3 to the first resin layer 2. Since the mold 3 and the method of pressurizing are the same as the pressing step described in (2) of 1. Photo-imprinting process, the description thereof is omitted. Note that at least either the first substrate 1 or the mold 3 must transmit light having the first wavelength.

### (3) Exposure Step

As shown in (3) of FIG. 1, the exposure step is a step of irradiating the first resin layer 2 with light having the first wavelength. Since the light source of the light having the first wavelength and the method of irradiation with light are the same as the first exposure step described in (3) of 1. Photo-imprinting process, the description thereof is omitted.

### (4) Pattern Forming Step

As shown in (4) of FIG. 2, the pattern forming step is a step of forming a pattern by detaching the mold 3 form the first resin layer 2. Since the concrete method of the detachment is the same as the pattern forming step described in (4) of 1. Photo-imprinting process, the description thereof is omitted.

### (5) Second Application Step

As shown in (5) of FIG. 2, the second application step is a step of forming a second resin layer 4 by applying a crosslinking/curing resin onto the pattern on the first substrate 1. As the crosslinking/curing resin used here, any known resin that crosslinks/cures at least either by irradiation with light having a wavelength longer than the second wavelength or by heating and is not resolubilized in a solvent by irradiation with light and heating can be used without particular problems.

In order to reduce the production process, the light used for crosslinking/curing resin of the photocrosslinking/curing resin preferably has the same wavelength as the first wavelength. When the first resin layer 2 is formed of a rework type photocrosslinking/curing resin that is decomposed by heating, in order to avoid decomposition of the first resin layer, it is preferable not to use a crosslinking/curing resin that crosslinks/cures by heating.

Examples of the crosslinking/curing resin include resins containing a multifunctional methacrylic monomer, a multifunctional acrylic monomer, or a multifunctional epoxy resin (prepolymer) and a polymerization initiator such as a photoradical polymerization initiator, a photoacid generator, or a thermopolymerization initiator.

Examples of the multifunctional methacrylic monomer include trimethylolpropane trimethacrylate, ethylene glycol dimethacrylate, and diethylene glycol dimethacrylate.

Examples of the multifunctional acrylic monomer include pentaerythritol triacrylate, pentaerythritol tetraacrylate, and trimethylolpropane triacrylate.

Examples of the multifunctional epoxy resin (prepolymer) include glycerol polyglycidyl ether, phenol novolak type epoxy resins, and bisphenol A type epoxy resins.

The photoradical polymerization initiator and the photoacid generator may the same as those used in the rework type photocrosslinking/curing resin. Therefore, the description thereof is omitted.

Examples of the thermopolymerization initiator include azobisisobutyronitrile and benzoyl peroxide.

The application of the crosslinking/curing resin can be performed by a known method, such as spin coating or ink-jetting, as in the application step described in (1) of 1. Photo-imprinting process. The second resin layer 4 must have a thickness at least larger than that of the first resin layer 2 so as to cover over the pattern formed in the first resin layer 2.

### (6) Second Substrate Disposing Step

As shown in (6) of FIG. 2, the second substrate disposing step is a step of disposing a second substrate 5 on the second resin layer 4. Specifically, the upper side of the second resin layer 4 is covered by the second substrate 5, and then the second substrate 5 and the second resin layer 4 are applied with a pressure and fixed not to separate from each other. Since the method of pressurizing and the pressure level are the same as those in the pressing step described in (2) of 1. Photo-imprinting process, the description thereof is omitted.

As the second substrate 5, any substrate that is usually used in photo-imprinting processes can be used without particular limitation. For example, in addition to a silicon monocrystal plate and a nickel plate, those made of materials having flexibility, such as a polyethylene terephthalate (PET) film, can be used. Note that at least one of the first substrate and the first substrate must transmit light having the second wavelength and light for crosslinking/curing the second resin layer 4.

When a mold is duplicated using a material having flexibility, the mold can be attached to an outer surface of a roller, and imprinting can be sequentially performed with high efficiency by using the roller.

### (7) Second Resin Layer Crosslinking/Curing Step

When the second resin layer is formed of a crosslinking/curing resin that crosslinks/cures by irradiation with light, the second resin layer crosslinking/curing step is, as shown in (7) of FIG. 2, a step of crosslinking/curing the second resin layer 4 by irradiating the second resin layer 4 with light having a wavelength longer than the second wavelength.

The light having a wavelength longer than the second wavelength is preferably light having the first wavelength for simplifying the manufacturing apparatus, as described above. Since the method of exposure is the same as the first exposure step described in (3) of 1. Photo-imprinting process, the description thereof is omitted.

When the second resin layer is formed of a crosslinking/curing resin that crosslinks/cures with heating, a known method, for example, heating with a heater disposed on the lower side of the first substrate 1 or the upper side of the second substrate 5, can be employed without particular limitation.

### (8) Solubilization Step

As shown in (8) of FIG. 2, the solubilization step is a step of solubilizing the pattern formed on the first substrate 1 by intramolecularly decomposing the crosslinked/cured rework type photocrosslinking/curing resin by, for example, irradiation with light having the second wavelength. When the first substrate 1 transmits light having the second wavelength, as shown in (8) of FIG. 2, the first substrate 1 side may be irradiated with the light having the second wavelength. If the second substrate 5 transmits light having the second wavelength, the second substrate 5 side may be irradiated with the light.

The resolubilization of the pattern by heating may be performed by any known method, for example, heating with a heater disposed on the lower side of the first substrate 1 or the upper side of the second substrate 5 without particular limitation.

### (9) Removal Step

The removal step is a step of removing the first substrate 1 and the pattern formed thereon. As a result of this step, a mold replica 10 is obtained. As the removal method, any conventionally known process for washing precise parts can be used without particular limitation. Specifically, for example, after completion of the solubilization step (8), a method of applying ultrasonic vibration to a solvent in which the mold replica is immersed, a method of stirring a solvent in which the mold replica is immersed, or a method of blowing out the first substrate 1 and the patter by spraying a solvent can be used.

In the removal step, any organic solvent or aqueous solvent that does not dissolve, swell, and deform the second resin layer can be used, but, for example, water, alkali aqueous solutions, hot water, ethanol, and methanol are low in load imposed on the natural environment and are therefore preferred. Furthermore, a mixture of a plurality of solvents may be used according to need.

Thus, in the mold-duplicating process of the invention, a rework type photocrosslinking/curing resin is used as the first resin layer 2. Accordingly, a highly precise mold can be easily duplicated by, for example, a photo-imprinting process.

### 3. Other Rework Type Photocrosslinking/Curing Resin

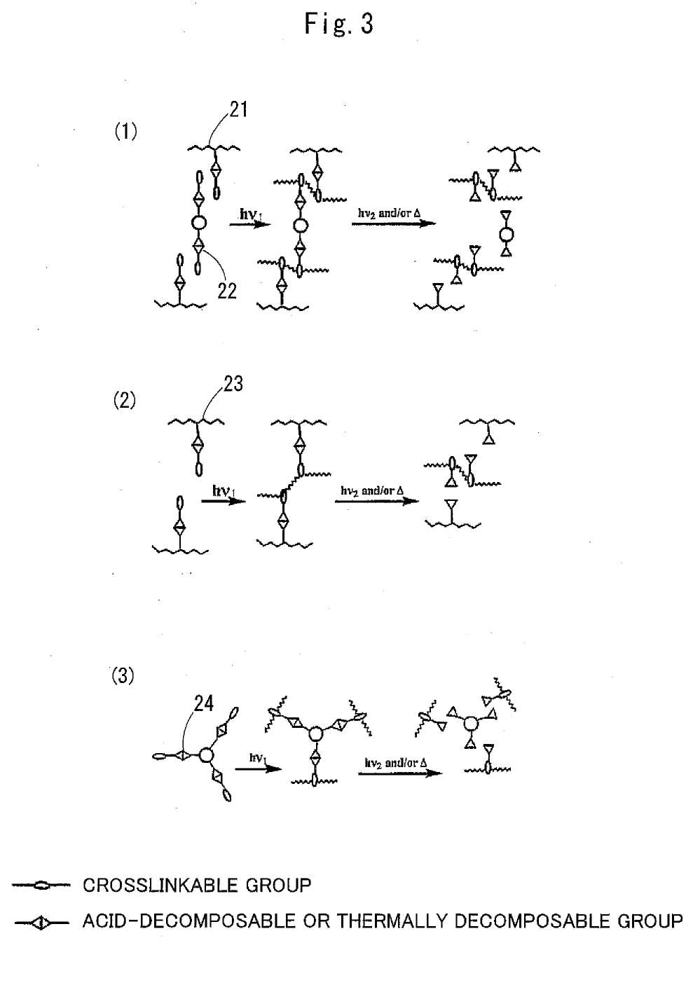

The rework type photocrosslinking/curing resin is not limited to the above-mentioned examples, and other various resins can be used. For example, (1) a mixture type of a polymer and a crosslinking agent, (2) a polymer type having a functional group on its side chain, or (3) a multifunctional monomer type can be used. Accordingly, their details will be described below based on FIG. 3.

### (1) Mixture Type of a Polymer and a Crosslinking Agent

The rework type photocrosslinking/curing resin of this type contains a polymer 21 and a crosslinking agent 22, as shown in (1) of FIG. 3. The polymer 21 has a crosslinkable group on the end of the side chain and has an acid-decomposable group or a thermally decomposable group between the crosslinkable group and the main chain. The crosslinking agent 22 has a crosslinkable group on the end and has an acid-decomposable group or a thermally decomposable group in its molecule.

These polymer 21 and the crosslinking agent 22 can be used as a rework type photocrosslinking/curing resin by combining the crosslinkable groups, the acid-decomposable groups, and the thermally decomposable groups in their molecules with, for example, a radical polymerization initiator, a photoacid generator, and a heating process that crosslink or decompose them.

The crosslinkable groups are functional groups that can bind to each other by means of, for example, an acid, in addition to the radical described in 1. Photo-imprinting process, and examples thereof include epoxy groups, oxetane groups, and vinyl ether groups. The acid-decomposable groups and the thermally decomposable groups are the same as those described in 1. Photo-imprinting process.

(2) Polymer Type having a Functional Group on the Side Chain

As shown in (2) of FIG. 3, the rework type photocrosslinking/curing resin of this type contains, for example, a polymer 23. This polymer 23 is the same as the polymer 21 shown in (1) of FIG. 3 and can be used, as in the polymer 21, as a rework type photocrosslinking/curing resin by being combined with a radical polymerization initiator, a photoacid generator, and so on.

### (3) Multifunctional Monomer Type

As shown in (3) of FIG. 3, the rework type photocrosslinking/curing resin of this type contains a monomer 24 having a crosslinkable group on the end of its side chain and having an acid-decomposable group or a thermally decomposable group between the end of the side chain and the main chain. The crosslinkable group, the acid-decomposable group, and the thermally decomposable group of this monomer 24 are the same as those described in (1), and the monomer 24 can be used as a rework type photocrosslinking/curing resin by being combined with a radical polymerization initiator, a photoacid generator, and so on.

The present invention will be described based on examples below, but the claims of the invention are not limited by the following examples in any sense.

### EXAMPLE 1

### 1. Synthesis of Monomer DCA3

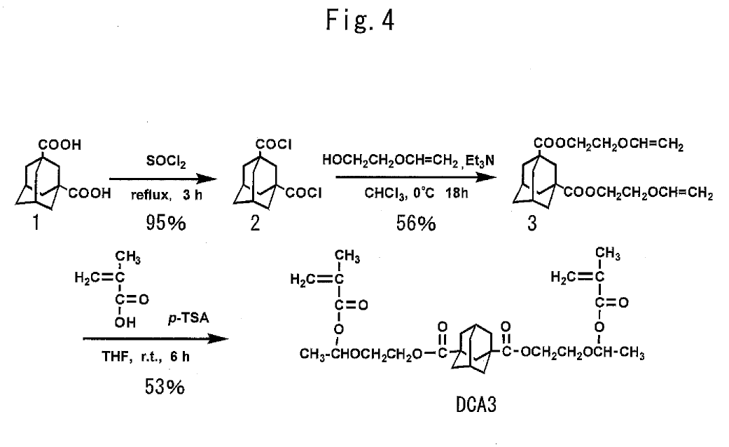

A monomer DCA3 having photoradical polymerizable crosslinkable groups on both ends and having an acid-decomposable group between the crosslinkable groups was synthesized along the reaction path shown in FIG. 4. The detail will be described below. Note that the same compounds are designated with the same reference numerals in order to clarify the relationship between FIG. 4 and the following description.

### (1) Reagent

1,3-Adamantane dicarboxylic acid (hereinafter abbreviated as compound 1) purchased from Tokyo Kasei Kogyo Co., Ltd., was directly used. Thionyl chloride, 2-vinyloxyethanol, triethylamine, and p-TSA were purchased from Aldrich, and they were directly used.

### (2) Measuring Apparatus

The ¹H-NMR spectrum was measured with an FT-NMR spectrometer (JEOL, GX-270). The IR spectrum was measured with an FT-IR spectrometer (JASCO, FT/IR-410). The melting point (mp) was measured with a thermogravimetric analyzer (Shimadzu Corp., TGA-50).

### (3) Synthesis of Monomer

### 1) Synthesis of tricyclo[3.3.1.13,7]decane-1,3-dicarbonyl dichloride

The synthesis was performed according to the description in the literature (M. D. Heagy, Q. Wang, G. A. Olah, G. K. S. Prakash, J. Org. Chem., 60, 7351 (1995)). Specifically, compound 1 (1.9 g, 8.5 mmol) was placed in a two-neck flask, and thionyl chloride (25 mL) was added thereto under nitrogen. The contents of the flask was refluxed for 3 hr, and then excessive thionyl chloride was distilled away by evaporation to dryness to obtain a white solid of tricyclo[3.3.1.13,7]decane-1,3-dicarbonyl dichloride (hereinafter abbreviated as compound 2) (crude amount: 2.1 g, crude yield: 95%). This compound 2 was identified from the analytical result shown below.

mp: 74-75° C., IR (KBr) 2950, 1780 cm⁻¹

### 2) Synthesis of tricyclo[3.3.1.13,7]decane-1,3-dicarboxylic acid bis(2-vinyloxyethylene) ester

2-Vinyloxyethanol (2.0 g, 22.7 mmol), triethylamine (4.0 mL), and chloroform (10 mL) were placed in a three-neck flask, and a chloroform solution (15 mL) containing compound 2 (2.1 g, 8.1 mmol) was dropped thereto under nitrogen at 0° C., followed by stirring for 18 hr at room temperature.

The reaction mixture was transferred to a separatory funnel and was washed with 1 M hydrochloric acid until neutral and then with an aqueous solution of saturated sodium hydrogen carbonate and ion-exchanged water. The organic layer was collected and dried over anhydrous magnesium sulfate, and the solvent was distilled away. The remaining colorless transparent liquid was subjected to purification with a silica gel medium-pressure column (developing solvent: chloroform) to obtain a colorless viscous liquid of tricyclo[3.3.1.13,7]decane-1,3-dicarboxylic acid bis(2-vinyloxyethylene) ester (hereinafter abbreviated as compound 3) (amount: 1.53 g, yield: 56%). Compound 3 was identified from the analytical result shown below.

¹H-NMR (CDCl₃): δ 6.5 (2H, q, O—CH═CH₂, Ha), 4.2 (4H, t, —C(═O)—CH₂—, Hb), 4.1, 3.9 (4H, dd, O—CH═CH₂, Hc), 3.8 (4H, t, —CH₂—O, Hd), 2.1-1.6 (14H, m, adamantane, He)

3) Synthesis of DCA3

A THF (6 mL) solution of p-TSA (36 mg, 0.21 mmol) and methacrylic acid (1.08 g, 12.6 mmol) were placed in a three-neck flask under nitrogen, and 10 mL of a THF solution of compound 3 (1.53 g, 4.2 mmol) was added to the three-neck flask, followed by stirring in a water bath for 6 hr.

THF was distilled away from the reaction mixture with an evaporator, and diethyl ether was added thereto. The resulting diethyl ether solution was transferred to a separatory funnel and was washed with an aqueous solution of saturated sodium hydrogen carbonate and saturated saline each three times. The organic layer was collected and dried over anhydrous magnesium sulfate, and the solvent was distilled away with an evaporator. The remaining colorless transparent liquid was subjected to purification with a silica gel medium-pressure column (developing solvent: chloroform) to obtain a colorless viscous liquid of DCA3 (amount: 1.2 g, yield: 53%). DCA3 was identified from the analytical result shown below.

¹H-NMR (CDCl₃): δ 6.1, 5.6 (4H, s, CH₂═C, Ha), 6.0-5.9 (2H, m, O—CH(CH₃)—O, Hb), 4.2 (4H, t, —C(═O)—CH₂—, Hc), 3.8-3.6 (4H, m, —CH₂—O, Hd), 1.6-2.1 (14H, m, adamantane, He), 1.9 (6H, s, —CH₂, Hf), 1.3 (6H, m, O—CH(CH₃)—O, Hg)

### EXAMPLE 2

### 2. Photo Imprint

A rework type photocrosslinking/curing resin containing DCA3 synthesized in Example 1 was prepared, and a pattern was transferred by a photo-imprinting process using this rework type photocrosslinking/curing resin. The detail thereof will be described below. Note that the following operation was performed in a darkened clean room unless otherwise defined.

### (1) Reagents and so on

DCA3 synthesized in Example 1 was used as a monomer. The photoradical polymerization initiator was DMPA (a product of Tokyo Kasei Kogyo Co., Ltd.), and the photoacid generator was BBI-105 (trade name, a product of Midori Kagaku Co., Ltd.). As the substrate, a quartz plate (25 mm×25 mm, thickness: 1 mm) was used.

### (2) Apparatus

1H-D3 (a product of Mikasa Co., Ltd.) was used as a spin coater, and MNI-1000HC (a product of Maruni Co., Ltd.) was used as an imprinting apparatus. As the light source of light having the first wavelength (365 nm), Ushio UM-102 (a product of Ushio Inc.) to which a glass filter UV-D36B (a product of Toshiba Glass Co.) was attached was used. Furthermore, as the mold, a nickel mold having a size of 25 mm×25 mm, a line width of 20 μm, and a groove depth of 1 μm was used.

### (3) Preparation of Rework Type Photocrosslinking/Curing Resin

The monomer, the photoradical polymerization initiator, and the photoacid generator were placed in a beaker at a weight ratio of 100:1:1 and were mixed using a magnetic stirrer for 5 to 10 min to prepare a rework type photocrosslinking/curing resin.

### (4) Photo Imprint

The prepared rework type photocrosslinking/curing resin was dropped onto a surface of the quartz plate with a syringe (application step). The substrate was set on the photo-imprinting apparatus, and the mold was placed on the resin layer and was pressed at a pressure of 0.8 MPa (pressing step).

Irradiation toward the resin layer with light having the first wavelength was performed for 3 min from the quartz plate side (first exposure step). The substrate and the mold adhering thereto were together removed from the photo-imprinting apparatus, and then the mold was detached from the substrate to obtain a transcript (hereinafter abbreviated as primary pattern) of the mold (pattern forming step).

### EXAMPLE 3

### 3. Duplication of Mold

The photo-imprinting process described in Example 2 was applied to duplication of a mold. The detail will be described below. Note that the following operation was performed in a darkened clean room unless otherwise defined.

### (1) Reagents and so on

As the photocrosslinking/curing resin, PAK-01 (trade name, a product of Toyo Gosei Co., Ltd.) was used. The modified PET film having a thickness of 1 mm was a general product (manufactured by Acrylsunday Co., Ltd.). As the light source of light having the second wavelength (254 nm), Ushio ULO-6DQ (a product of Ushio Inc.) was used.

### (2) Duplication of Mold

A quartz plate provided with a pattern having a thickness of about 1 μm was obtained by the photo-imprinting process using the rework type photocrosslinking/curing resin, described in Example 2 (first application step, pressing step, exposure step, pattern forming step). A second resin layer was formed by dropping the photocrosslinking/curing resin onto the surface of the first substrate on which the pattern was formed (second application step).

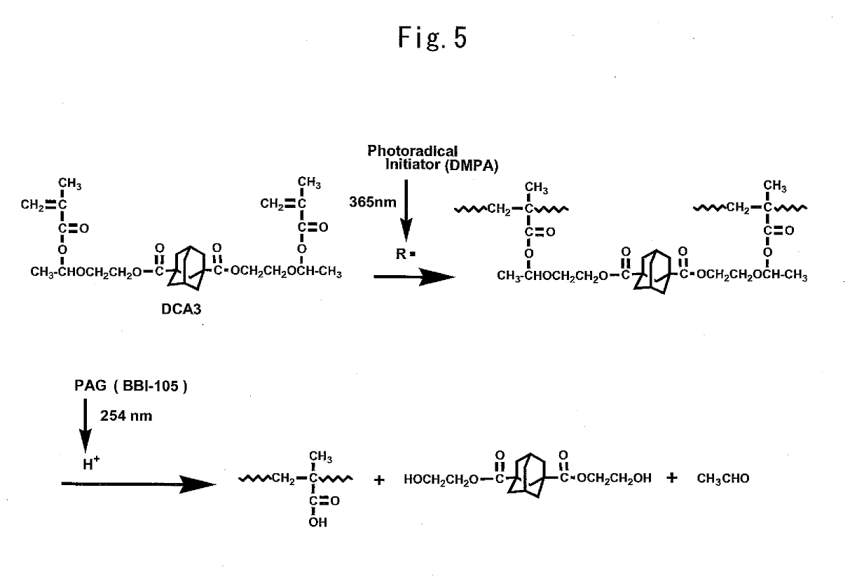

The PET film was placed on the second resin layer, and this was set on the photo-imprinting apparatus and was held in the state of being pressed with a pressure of 12 MPa (second substrate disposing step). In this state, the pattern and the second resin layer were irradiated with light having the first wavelength (365 nm) through the first substrate for 3 min to crosslink/cure the second resin layer (second resin layer crosslinking/curing step) and were subsequently continuously irradiated with light having the second wavelength (254 nm) for 5 min to resolubilize the pattern portion only (solubilization step). FIG. 5 shows changes of the rework type photocrosslinking/curing resin by irradiation with light having the first wavelength and the second wavelength.

The quartz plate after the resolubilization of the pattern was immersed in methanol to remove the quartz plate from the PET film and also to dissolve the pattern present in the second resin layer (removal step). Lastly, the PET film was naturally dried to obtain a mold replica (hereinafter abbreviated as secondary pattern) on the PET film.

### EXAMPLE 4

### 4. Evaluation of Transferability and Duplicatability

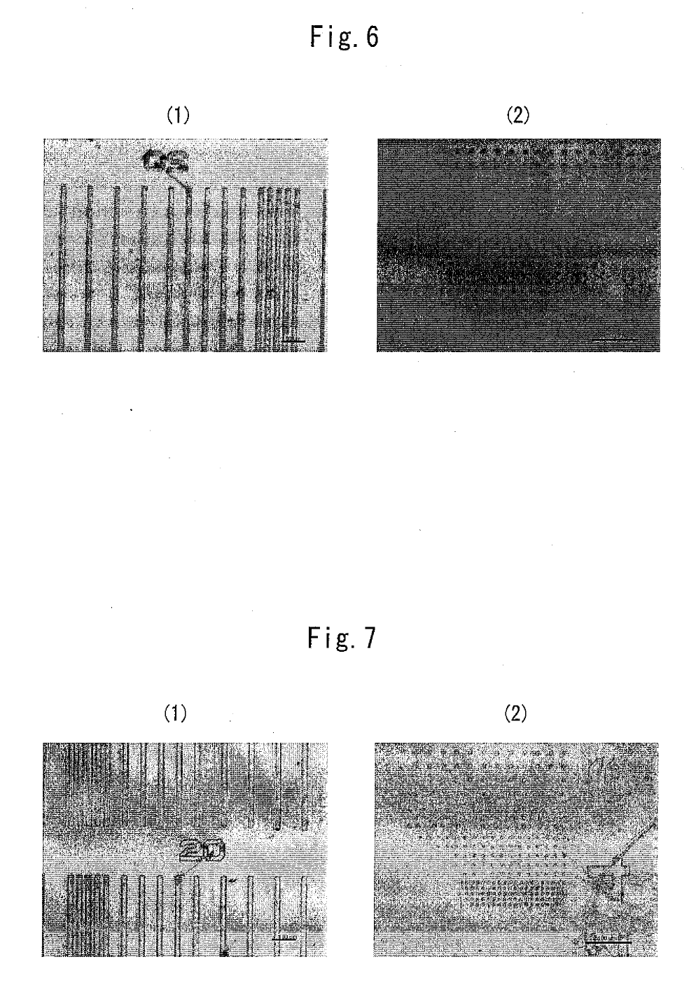

The primary pattern produced in Example 2 and the secondary pattern produced in Example 3 were observed and measured with an optical microscope and a profilometer for evaluating transferability of the photo-imprinting process and duplicatability of the mold-duplicating process of the invention. As the optical microscope, Nikon 245377 (a product of Nikon Corp.) was used. The profilometer was ET-3000 (a product of Kosaka Laboratory Ltd.). FIGS. 6 to 8 show the results of the observation and the measurement.

FIG. 6 is optical micrographs of the primary patterns, and FIG. 7 is optical micrographs of the secondary patterns. The optical micrographs shown in (1) and (2) of both Figures are, respectively, those when the same mold was used. It was confirmed from these figures that a mold could be transferred to a substrate and duplicated without causing disarrangement in the pattern.

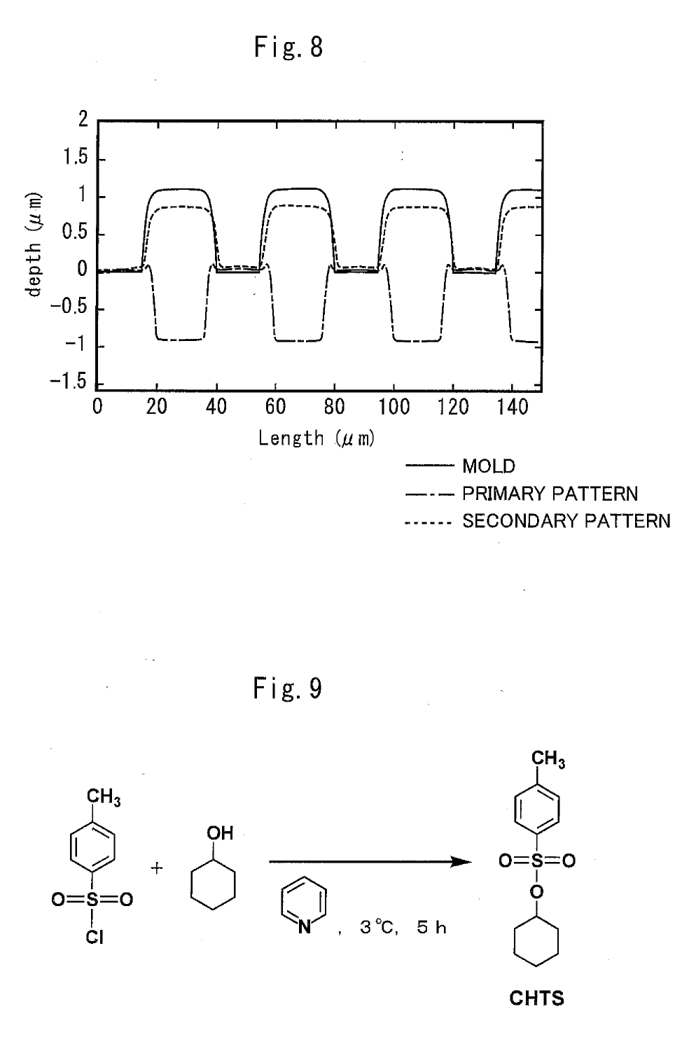

FIG. 8 is a graph showing measured results with a profilometer. It was confirmed from this graph that the line width and the height of the primary pattern were approximately the same as those of the mold. On the other hand, it was confirmed that, in the secondary pattern, the line width was completely the same, but that the height was shortened about 10%. That is, in addition to the results of observation with the optical microscope, it was also confirmed by the results of the profilometer that a mold could be transferred to a substrate and duplicated with high precision.

### EXAMPLE 5

### 5. Synthesis of Thermoacid Generator

A thermoacid generator, CHTS, which generates an acid by decomposed by heat was synthesized according to the reaction path shown in FIG. 9. The detail will be described below.

### (1) Reagents and so on

Cyclohexanol purchased from Aldrich was directly used. Pyridine purchased from Aldrich was distilled and then used (distilled pyridine). P-Toluenesulfonyl chloride purchased from Tokyo Kasei Kogyo Co., Ltd., was directly used. The measuring apparatuses were the same as those used in Example 1, but the thermal decomposition temperature was measured with a thermogravimetry differential thermal analyzer DTG-60 (a product of Shimadzu Corp.).

### (2) Synthesis of Thermoacid Generator

Cyclohexanol (2.6 g, 26.0 mmol) and distilled pyridine (31 mL) were placed in a 100-mL four-neck flask equipped with a calcium chloride tube and a thermometer. P-toluenesulfonyl chloride (5.0 g, 26.2 mmol) was gradually added to the flask, which was cooled to and maintained at 3° C. or lower with an ice bath, using a funnel for solid, followed by stirring for 5 hr.

The reaction solution was fed into a separatory funnel containing a sulfuric acid aqueous solution (4 N, 150 mL) cooled with ice (on this occasion, confirmed that the pH after the feeding was pH 1) and was extracted from 100 mL of chloroform three times, followed by washing with 150 mL on ion-exchanged water twice and 150 mL of an aqueous solution of saturated sodium hydrogen carbonate twice. The chloroform phase was collected and dried over anhydrous magnesium sulfate, and the solvent was distilled away.

The obtained yellow liquid (4.0 g) was subjected to purification with a silica gel medium-pressure column (developing solvent: chloroform), followed by vacuum drying to obtain 3.5 g of a colorless transparent liquid. This colorless transparent liquid was dissolved in 80 mL of hexane and left for stand in a freezer overnight. Then, the precipitated white crystal was collected by filtration and was vacuum dried to obtain CHTS (amount: 2.8 g, yield: 42%) as a white needle crystal. CHTS was identified from the analytical result shown below.

Thermal decomposition temperature: 130° C., ¹H-NMR (300 MHz, CDCl₃): δ 7.73, 7.26 (d, 4H, aromatic), 4.43 (m, 1H, CH), 2.38 (s, 3H, CH₃), 1.77-1.12 (br, 10H, —(CH₂)—).

### EXAMPLE 6

### 6. Photo Imprint

A rework type photocrosslinking/curing resin containing DCA3 synthesized in Example 1 and CHTS synthesized in Example 5 was prepared, and a pattern was transferred by a photo-imprinting process using this rework type photocrosslinking/curing resin. The detail thereof will be described below. Note that the following operation was performed in a darkened clean room unless otherwise defined.

### (1) Reagents and so on

DCA3 synthesized in Example 1 was used as the monomer. DMPA (a product of Tokyo Kasei Kogyo Co., Ltd.) was used as the photoradical polymerization initiator, and CHTS synthesized in Example 5 was used as the thermoacid generator. The same apparatuses used in Example 2 were used, but as the first substrate, a quartz plate (25 mm×25 mm, thickness: 1 mm) having a surface treated with hexamethyldisilazane (HMDS) was used. As the mold, a quartz mold having a size of 25 mm×25 mm, a line width of 10 μm, and a groove depth of 1 μm was used.

### (2) Preparation of Rework Type Photocrosslinking/Curing Resin

The monomer, the photoradical polymerization initiator, and the thermoacid generator were placed in a beaker at a weight ratio of 100:1:5 and were mixed using a magnetic stirrer for 5 to 10 min to prepare a rework type photocrosslinking/curing resin.

### (3) Photo Imprint

The prepared rework type photocrosslinking/curing resin was dropped onto a surface of the substrate with a syringe (application step). The substrate was set on the photo-imprinting apparatus, and the mold was placed on the resin layer and was pressed at a pressure of 0.8 MPa (pressing step).

Irradiation toward the resin layer with light having the first wavelength was performed from the quartz mold side for 3 min (first exposure step, exposure light intensity: 200 mJ/cm²). The substrate and the mold adhering thereto were removed together from the photo-imprinting apparatus, and then the mold was detached from the substrate to obtain a transcript (hereinafter abbreviated as primary pattern) of the mold (pattern forming step).

### EXAMPLE 7

### 7. Duplication of Mold

A quartz mold was duplicated using the pattern transferred in Example 6. The detail will be described below. Note that the following operation was performed in a darkened clean room unless otherwise defined. In order to distinguish two substrates, the substrate in Example 6 is called the first substrate hereafter.

### (1) Reagents and so on

As the photocrosslinking/curing resin, a mixture of A-TMM-3L NEW (a product of Shin-Nakamura Chemical Co., Ltd.) and DMPA (1 wt %, a product of Tokyo Chemical Industry Co., Ltd.) was used. The same apparatuses used in Example 3 were used, but as the second substrate, a silicon plate (second substrate) having a surface treated with 3-(trimethoxysilyl)propyl methacrylate was used. As the hot plate, Model HM-15, a product of Koike Precision Instruments, was used.

### (2) Duplication of Mold

A photocrosslinking/curing resin was dropped onto the pattern having a thickness of about 1 μm on the first substrate obtained in Example 6 to form a second resin layer (second application step). The second substrate was placed on the second resin layer, and this was set on the photo-imprinting apparatus and was held in the state being pressed with a pressure of 0.8 MPa (second substrate disposing step).

In this state, the pattern and the second resin layer were irradiated with light having the first wavelength (365 nm) through the first substrate for 3 min (exposure light intensity: 200 mJ/cm²) to crosslink/cure the second resin layer (second resin layer crosslinking/curing step).

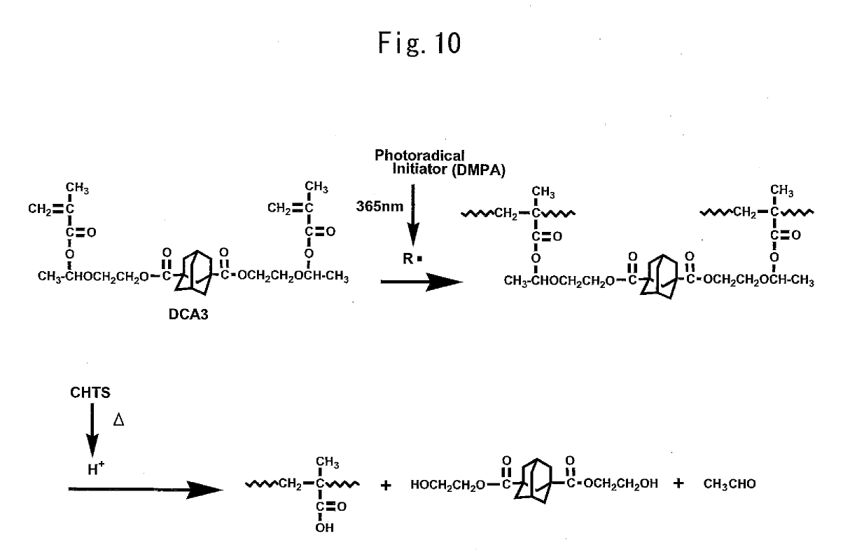

The first substrate and the second substrate in the stacked state were removed from the photo-imprinting apparatus and were then heated on the hot plate of 140° C. for 10 min to resolubilize the pattern portion only (solubilization step). FIG. 10 shows changes of rework type photocrosslinking/curing resin by the irradiation with light having the first wavelength and the heating.

The first substrate and the second substrate in the stacked state were immersed in methanol to remove the second substrate from the first substrate and also to dissolve the pattern present in the second resin layer (removal step). Lastly, the second substrate was naturally dried to obtain a mold replica (hereinafter abbreviated as secondary pattern) on the second substrate.

### EXAMPLE 8

### 8. Evaluation of Transferability and Duplicatability

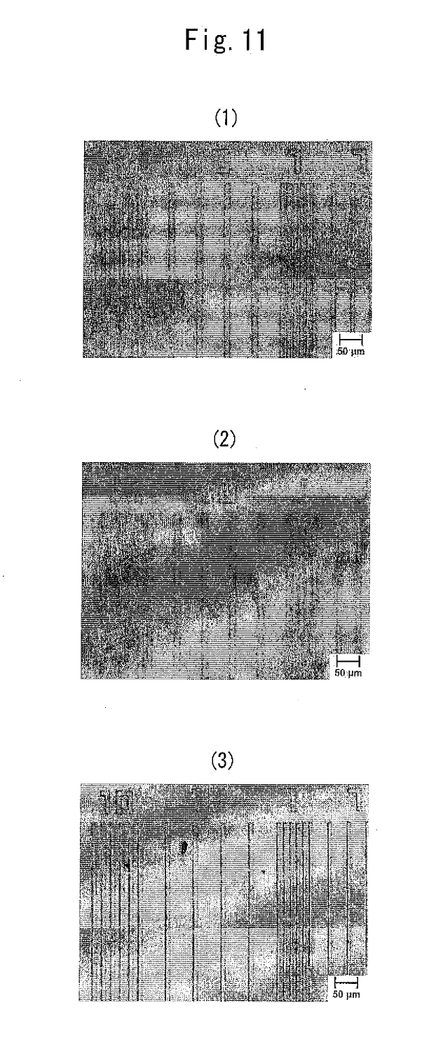

The primary pattern produced in Example 6 and the secondary pattern produced in Example 7 were observed with an optical microscope for evaluating the transferability of the photo-imprinting process and the duplicatability of the mold-duplicating process of the invention. The same optical microscope in Example 4 was used. FIG. 11 shows the results.

In FIG. 11, (1) is an optical micrograph of the mold, (2) is an optical micrograph of the primary pattern, and (3) is an optical micrograph of the secondary pattern. It was confirmed from these photographs that a mold having a line width of 10 μm can be satisfactorily transferred to a substrate by the photo-imprinting process of the invention and that a mold having a line width of 10 μm can be satisfactorily duplicated by the mold-duplicating process of the invention.

1. A photo-imprinting process comprising, in the following order:
an application step (1) of forming a resin layer by applying, to a substrate, a rework type photocrosslinking/curing resin that crosslinks/cures by irradiation with light having a first wavelength and is resolubilized in a solvent by irradiation with light having a second wavelength shorter than the first wavelength;
a pressing step (2) of pressing a mold to the resin layer;
a first exposure step (3) of irradiating the resin layer with light having the first wavelength; and
a pattern forming step (4) of forming a pattern by detaching the mold from the resin layer.

2. The photo-imprinting process according to claim 1, wherein the rework type photocrosslinking/curing resin includes:
a monomer (a) having photoradical polymerizable crosslinkable groups on both ends and an acid-decomposable group between the crosslinkable groups;
a photoradical polymerization initiator (b) that generates a radical by irradiation with light having the first wavelength; and
a photoacid generator (c) generating an acid by irradiation with light having the second wavelength.

3. The photo-imprinting process according to claim 2, wherein the photoradical polymerizable crosslinkable groups of the rework type photocrosslinking/curing resin are each a functional group selected from the group consisting of acrylate ester groups, methacrylate ester groups, vinylphenyl groups, and vinyl ester groups; and the acid-decomposable group of the rework type photocrosslinking/curing resin is a functional group selected from the group consisting of acetal groups, ketal groups, hemiacetal ester groups, tertiary carboxylate ester groups, carbonate ester groups, and sulfonate ester groups.

4. The photo-imprinting process according to claim 1, further comprising a second exposure step of irradiating the resin layer with light having the second wavelength.

5. The photo-imprinting process according to claim 1, further comprising a second exposure step of irradiating the mold detached from the resin layer with light having the second wavelength.

6-8. (canceled)

9. A mold-duplicating process comprising, in the following order:
a first application step (1) of forming a first resin layer by applying, to a first substrate, a rework type photocrosslinking/curing resin that crosslinks/cures by irradiation with light having a first wavelength and is resolubilized in a solvent at least either by irradiation with light having a second wavelength shorter than the first wavelength or by heating;
a pressing step (2) of pressing a mold to the first resin layer;
an exposure step (3) of irradiating the first resin layer with light having the first wavelength;
a pattern forming step (4) of forming a pattern by detaching the mold from the first resin layer;
a second application step (5) of forming a second resin layer by applying, onto the pattern, a crosslinking/curing resin that crosslinks/cures at least either by irradiation with light having a wavelength longer than the second wavelength or by heating and is not resolubilized in a solvent by irradiation with light and heating;
a second substrate disposing step (6) of disposing a second substrate on the second resin layer;
a second resin layer crosslinking/curing step (7) of crosslinking/curing the second resin layer at least either by irradiation with light having a wavelength capable of crosslinking/curing the second resin layer or by heating;
a solubilization step (8) of solubilizing the pattern at least either by irradiation with light having the second wavelength or by heating; and
a removal step (9) of removing the solubilized pattern and the first substrate.

10. The mold-duplicating process according to claim 9, wherein the rework type photocrosslinking/curing resin includes:
a monomer (a) having photoradical polymerizable crosslinkable groups on both ends and an acid-decomposable group between the crosslinkable groups;
a photoradical polymerization initiator (b) that generates a radical by irradiation with light having the first wavelength; and
at least one of a photoacid generator (c) generating an acid by irradiation with light having the second wavelength and a thermoacid generator (c) generating an acid by heating.

11. The mold-duplicating process according to claim 10, wherein the photoradical polymerizable crosslinkable groups of the rework type photocrosslinking/curing resin are each a functional group selected from the group consisting of acrylate ester groups, methacrylate ester groups, vinylphenyl groups, and vinyl ester groups; and the acid-decomposable group of the rework type photocrosslinking/curing resin is a functional group selected from the group consisting of acetal groups, ketal groups, hemiacetal ester groups, tertiary carboxylate ester groups, carbonate ester groups, and sulfonate ester groups.

12. The mold-duplicating process according to claim 9, further comprising a second exposure step of irradiating the mold detached from the first resin layer with light having the second wavelength.

13. The mold-duplicating process according to claim 9, wherein the rework type photocrosslinking/curing resin includes a monomer (d) having photocationic polymerizable crosslinkable groups on both ends and a thermally decomposable group between the crosslinkable groups; and a photoacid generator (e) generating an acid by irradiation with light having the first wavelength.

14. The mold-duplicating process according to claim 13, wherein the photocationic polymerizable crosslinkable groups of the rework type photocrosslinking/curing resin are each a functional group selected from the group consisting of epoxy groups, vinyl ether groups, and oxetane groups; and the thermally decomposable group of the rework type photocrosslinking/curing resin is a functional group selected from the group consisting of acetal groups, ketal groups, tertiary carboxylate ester groups, carbonate ester groups, and sulfonate ester groups.

15. The mold-duplicating process according to claim 9, further comprising a heating step of heating the mold detached from the first resin layer.

16. The mold-duplicating process according to claim 9, wherein the second substrate is made of a material having flexibility.

17. The mold-duplicating process according to claim 9, wherein the solvent used in the removal step contains at least one solvent selected from the group consisting of water, alkali aqueous solutions, hot water, ethanol, and methanol.

18. A mold replica that can be obtained by the mold-duplicating process according to claim 9.
